(19) United States
(12) Patent Application Publication
(10) Pub. No.: US 2022/0018343 A1
(43) Pub. Date: Jan. 20, 2022

(54) AIR INFLATOR DEVICE

(71) Applicants: Wen-San CHOU, Tainan City (TW); Cheng-Hsien CHOU, Tainan City (TW)

(72) Inventors: Wen-San CHOU, Tainan City (TW); Cheng-Hsien CHOU, Tainan City (TW)

(21) Appl. No.: 17/375,691

(22) Filed: Jul. 14, 2021

(30) Foreign Application Priority Data
Jul. 15, 2020 (TW) 109123963

(51) Int. Cl. F04B 39/06; F04B 35/06; F04B 39/12

(52) U.S. Cl. CPC F04B 39/066; F04B 39/121; F04B 35/06

(57) ABSTRACT

An air inflator device contains: an accommodation box and an air compressor. The accommodation box includes a cap and a case, and the air compressor and an air guiding mechanism are received in the cap and the case. The air guiding mechanism is configured to frame a cooling fan which is rotatably with a motor of the air compressor. A flowing orifice is defined by the first directing portion and the second directing portion, and a first semicircular cover and a second semicircular cover of the air guiding mechanism are configured to collect and guide airs so that the cooling fan rotates to guide the airs to the air compressor quickly, thus dissipating heat and prolonging a service life of the air compressor.

### FIELD OF THE INVENTION

The present invention relates to an air inflator device which dissipated heat and prolongs a service life of the air compressor.

### BACKGROUND OF THE INVENTION

A conventional air compressor has a small size so as to be portable onto a vehicle, thus inflating airs to tires or air cushions. The air compressor is started by using a portable DC power supply or being connected with a socket of a car cigarette lighter.

The air compressor is received in an accommodation box and is driven by a motor to actuate a piston of a cylinder to move back and forth, such that the airs are compressed and delivered to the air cushion and the tires, thus inflating the air cushions and the tires.

When the motor drives the piston of the cylinder to move back and forth, a high-temperature heat accumulates in a housing of the motor, because a rotor and the armature of a armature core, a armature winding and a commutator generate heat after the motor drives the rotor to rotate, and the commutator and the carbon brush have a friction to cause high temperature, thus gathering carbon of the carbon brush to interfere electric currents, reducing magnetic force of magnets, and have poor rotating efficiency of the motor.

Air inflator equipment is applied to inflate airs and feed sealant to a broken tire in a short time, but the heat resulting from a rotation of the rotor gathers in the housing of the motor to damage an insulation layer of the armature winding, thus burning the motor.

In addition, the air compressor is received in the accommodation box by multiple limitation bars or a fixing plate, however, it will case poor heat dissipation to damage the air compressor.

The present invention has arisen to mitigate and/or obviate the afore-described disadvantages.

### SUMMARY OF THE INVENTION

The primary aspect of the present invention is to provide an air inflator device contains an accommodation box and an air compressor, wherein the accommodation box includes a cap and a case, and the air compressor is received in the cap and the case, an air guiding mechanism is also received in the accommodation box and is configured to frame a cooling fan which is rotatably with a motor of the air compressor, such that the air guiding mechanism is configured to collect and guide airs so that the cooling fan rotates to guide the airs to the air compressor quickly, thus dissipating heat and prolonging a service life of the air compressor.

Further aspect of the present invention is to provide an air inflator device which contains the air guiding mechanism configured to collect and guide airs so that the cooling fan rotates to guide the airs to the air compressor quickly, thus dissipating heat and prolonging a service life.

Another aspect of the present invention is to provide an air inflator device which contains an air guiding mechanism received in the accommodation box and configured to frame the cooling fan which is rotatably with a motor of the air compressor, thus avoiding a strike of the cooling fan.

### BRIEF DESCRIPTION OF THE DRAWINGS

FIG. 1 is a perspective view showing the assembly of an air inflator device according to a first embodiment of the present invention.

FIG. 2 is a perspective view showing the assembly of a part of the air inflator device according to the first embodiment of the present invention.

FIG. 3 is a cross sectional view showing the assembly of the air inflator device according to the first embodiment of the present invention.

FIG. 4 is a side plan view showing the operation of the air inflator device according to the first embodiment of the present invention.

FIG. 5 is a perspective view showing the assembly of an air inflator device according to a second embodiment of the present invention.

FIG. 6 is a perspective view showing the assembly of a part of the air inflator device according to the second embodiment of the present invention.

FIG. 7 is a cross sectional view showing the assembly of the air inflator device according to the second embodiment of the present invention.

FIG. 8 is a side plan view showing the operation of the air inflator device according to the second embodiment of the present invention.

### DETAILED DESCRIPTION OF THE PREFERRED EMBODIMENTS

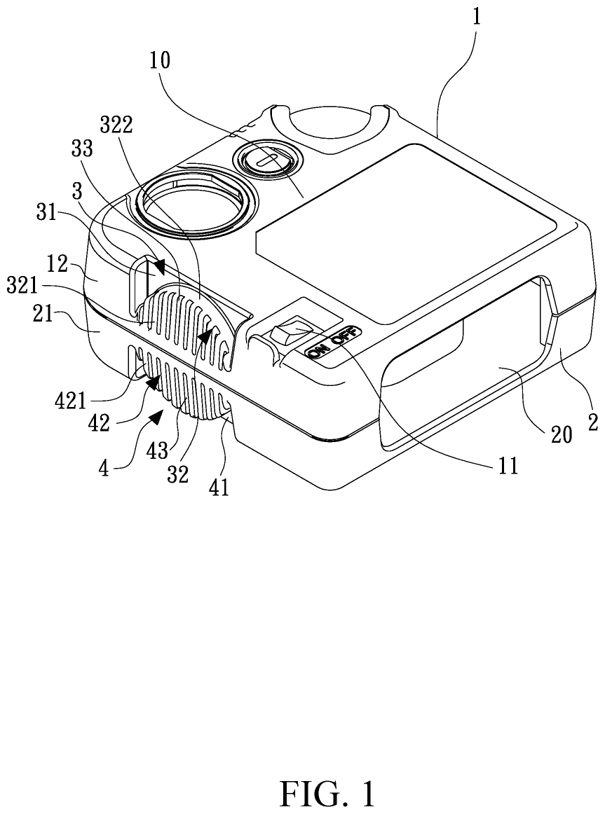

With reference to FIGS. 1-4, an air inflator device according to a first embodiment of the present invention comprises: an accommodation box and an air compressor 9, the accommodation box includes a cap 1 and a case 2, and the air compressor 9 is received in the cap 1 and the case 2. Furthermore, an air guiding mechanism is also received in the accommodation box and is configured to frame a cooling fan 91 which is rotatably with a motor 92 of the air compressor 9. The air guiding mechanism is configured to collect and guide airs so that the cooling fan 91 rotates to guide the airs to the air compressor 9 quickly, thus dissipating heat and prolonging a service life of the air compressor 9.

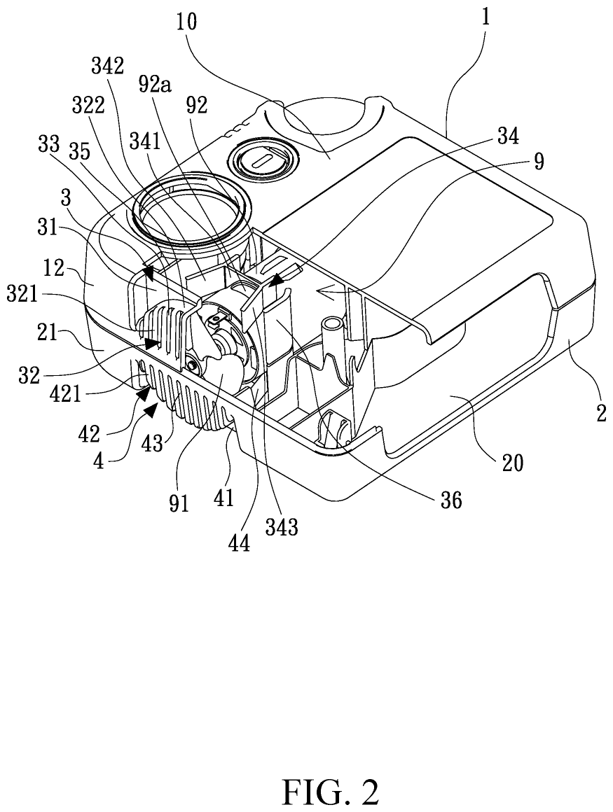

Referring to FIGS. 1 and 2, the cap 1 is formed in a rectangular frame shape and includes a first panel 10 formed on a top of the cap 1, a button 11 located beside the first panel 10 and configured to turn on/off the air compressor 9, a fluid guide structure which has a first directing portion 3, and the first directing portion 3 has a first recess 31 defined on a side of a first peripheral fringe 12 of the cap 1, and a first semicircular cover 32 extending on the first recess 31, wherein the first semicircular cover 32 has a first rib 321 and a first arcuate fence 322. The cap 1 further includes multiple first elongated orifices 33 separately formed on the first arcuate fence 322, and the first semicircular cover 32 is integrally formed with the cap 1.

Referring to FIGS. 1 and 2, the case 2 is formed in a rectangular frame shape and includes a fluid guide structure has a second directing portion 4 the same as the first directing portion 3. The second directing portion 4 has a second recess 41 defined on a side of a second peripheral fringe 21 of the case 2 below a second panel 20 of a top of the case 2, and a second semicircular cover 42 extending on the second recess 41, wherein the second semicircular cover 42 has a second rib 421 and a second arcuate fence 422. The cap 1 further includes multiple first elongated orifices 43 separately formed on the first arcuate fence 422, and the second semicircular cover 42 is integrally formed with the case 2.

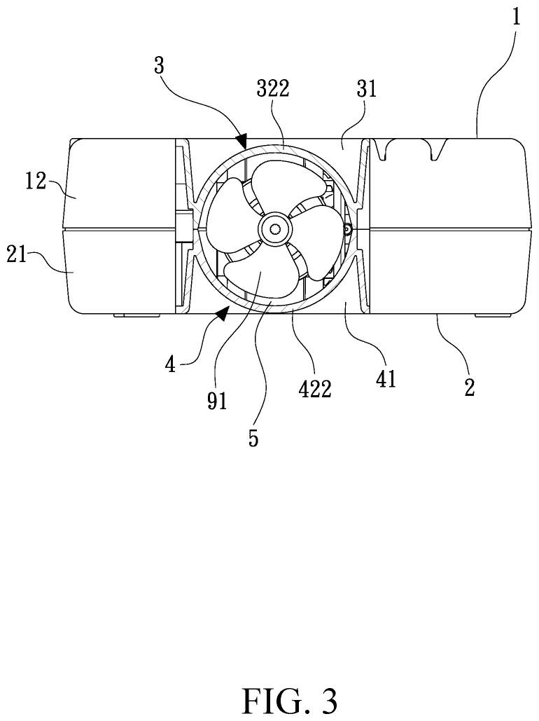

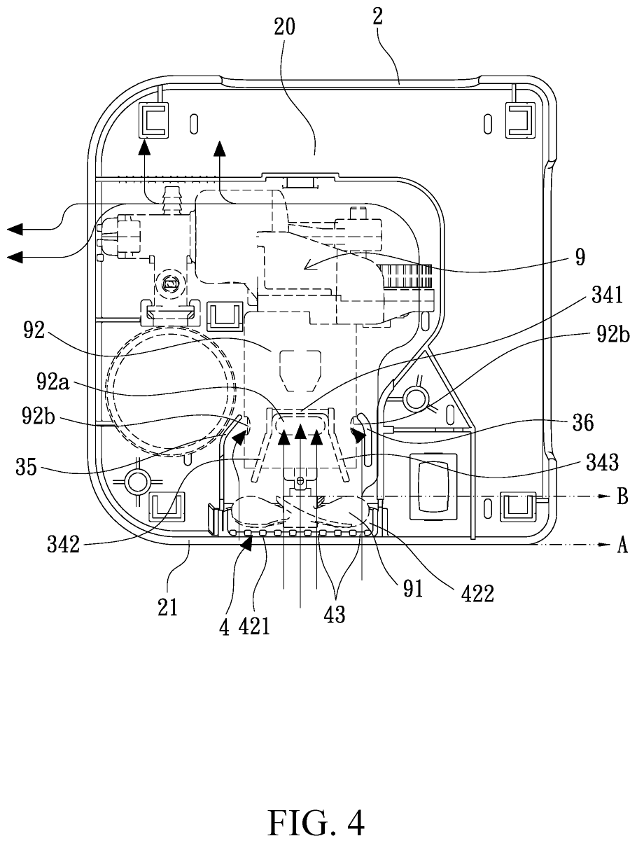

As shown in FIG. 3, after the air compressor 9 is received in the cap 1 and the case 2, the first directing portion 3 of the cap 1 and the second directing portion 4 of the case 2 frame the cooling fan 91, and the cooling fan 91 is rotatably with the motor 92 of the air compressor 9, thus avoiding a strike of the cooling fan 91. Furthermore, a flowing orifice 5 is defined by the first directing portion 3 and the second directing portion 4. As illustrated in FIG. 4, the air compressor 9 is received in the accommodation box and is dissipated heat. When the cooling fan 91 rotates to guide external airs to flow out of the flowing orifice 5 from the multiple first elongated orifices 33 and the multiple second elongated orifice 43 via the first directing portion 3 and the second directing portion 4 (as shown in FIG. 3), thus collecting and guiding the external airs smoothly.

With reference to FIG. 4, the air compressor 9 is received in the accommodation box, the cooling fan 91 is opposite to the accommodation box, wherein a first datum line A is defined between the first peripheral fringe 12 and the second peripheral fringe 21, a back line of the cooling fan 91 located in an air flowing zone is defined as a second datum line B, wherein the multiple first elongated orifices 33 and the multiple second elongated orifices 43 are located in an area between the first datum line A and the second datum line B. When the cooling fan 91 rotates, the external airs are drawn into the accommodation box from the multiple first elongated orifices 33 and the multiple second elongated orifices 43. In this embodiment, the multiple first elongated orifices 33 and the multiple second elongated orifices 43 are located on the first rib 321 and the second rib 421 in the area between the first datum line A and the second datum line B. Alternatively, the multiple first elongated orifices 33 and the multiple second elongated orifices 43 are defined on other portions of the accommodation box when a front end of the cooling fan 91 is defined in the area between the first datum line A and the second datum line B.

The first panel 10 of the cap 1 has a first fixing extension 34 extending on an inner wall thereof and configured to guide the airs and to fix the motor 92 of the air compressor 9, and the second panel 20 of the case 2 has a second fixing extension 44 extending on an inner wall thereof and configured to guide the airs and to fix the motor 92 of the air compressor 9. The first fixing extension 34 has a tilted face 341 formed on a center thereof, a first tilted fence 342 extending from a first end of the tilted face 341 to the first peripheral fringe 12, a second tilted fence 343 extending from a second end of the tilted face 341 to the first peripheral fringe 12, as shown in FIG. 4, wherein the tilted face 341, the first tilted fence 342, and the second tilted fence 343 guide the airs forward smoothly. Since a structure of the second fixing extension 44 is identical to that of the first fixing extension 34, the structure of the second fixing extension 44 is not shown.

The first panel 10 of the cap 1 has a first arcuate sheet 35 extending from an inner wall thereof, and the second panel 20 of the case 2 has a second arcuate sheet 36 extending from an inner wall thereof and corresponding to the first arcuate sheet 35, wherein a third arcuate sheet of the case is not shown.

The first fixing extension 34 of the cap 1 and the second fixing extension 44 of the case 2 abut against a first vent 92a of the motor 92 so that the tilted face 341 of the first fixing extension 34 and the second fixing extension 44 guide the airs to the first vent 92a of the motor 92 directly, the first arcuate sheet 35 and the second arcuate sheet 36 guide the airs to a second vent 92b, and the airs flow into the motor 92 from the first vent 92a and the second 92b, hence a heat resulting from a friction of a carbon brush and a commutator of the motor 92 and electric currents of armature winding are dissipated.

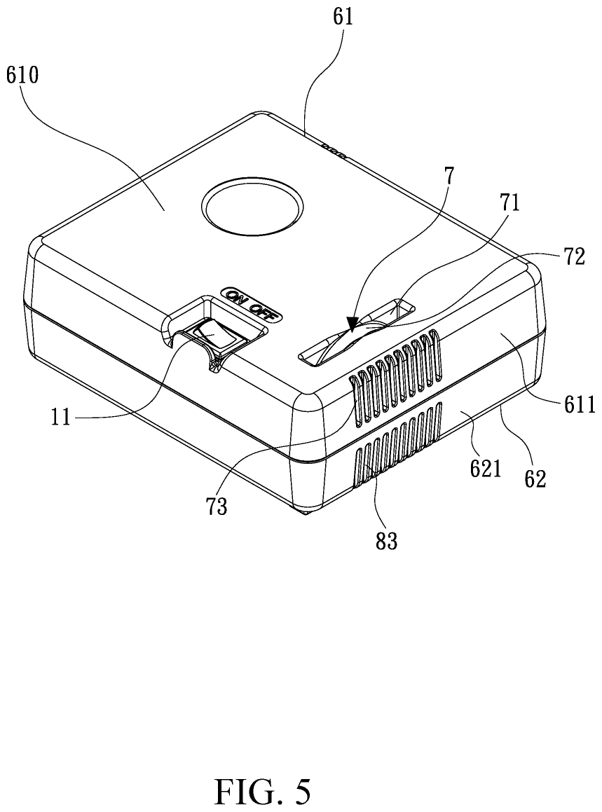

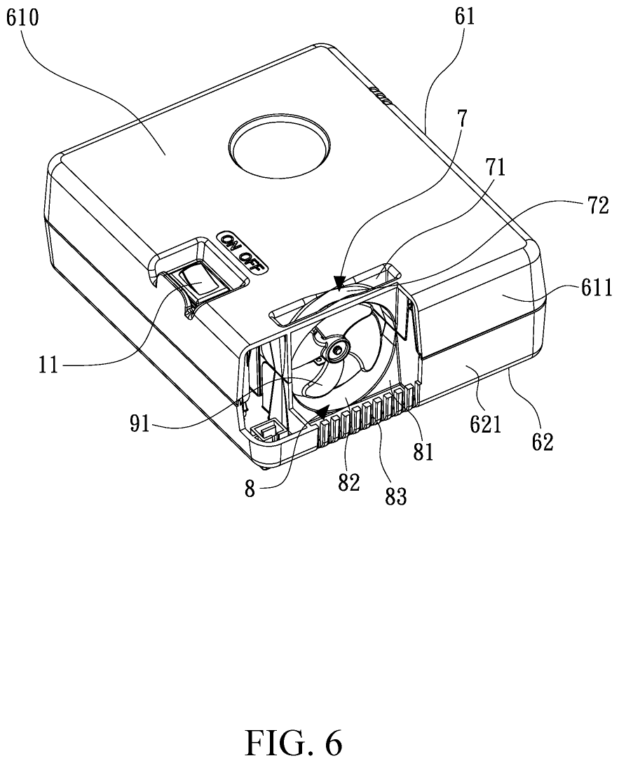

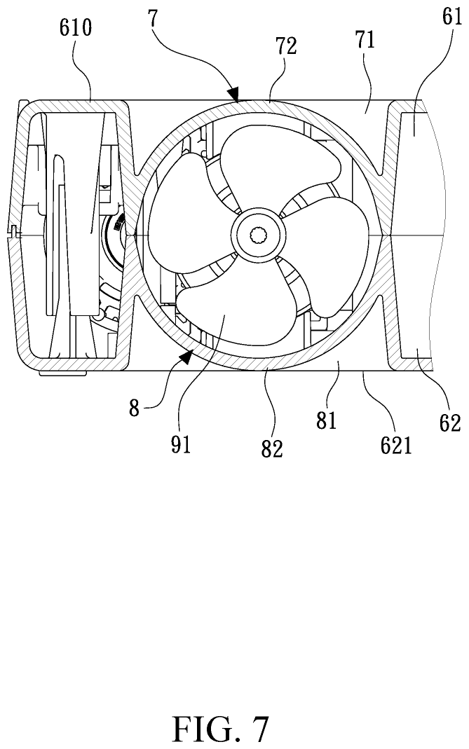

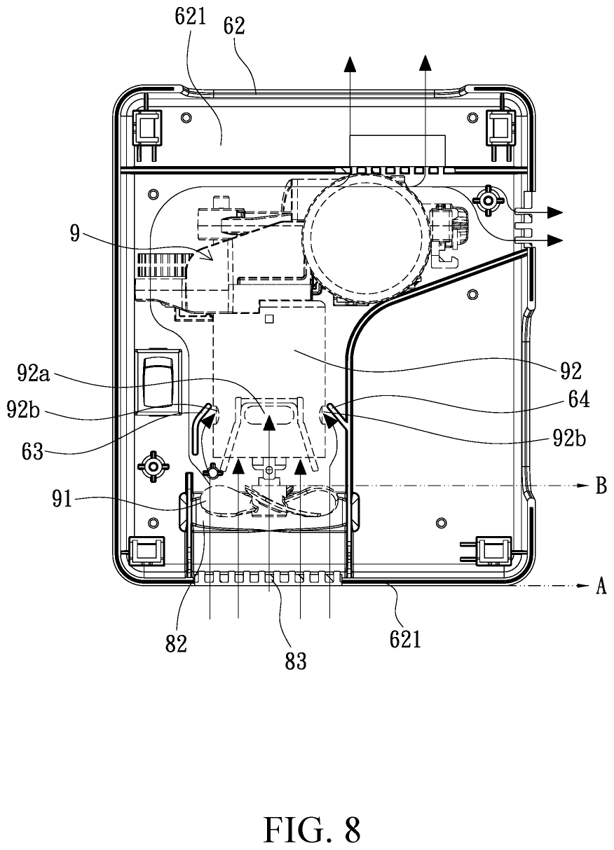

With reference to FIGS. 5-8, an air inflator device according to a second embodiment of the present invention comprises: a first recess 71 of a first directing portion 7 defined on a first panel 610 of a cap 61, and a first semicircular cover 72 integrally formed on the first recess 71, wherein the first semicircular cover 72 is arcuate, and the cap 1 further includes multiple first elongated orifices 73 separately formed on a side of a first peripheral fringe 611 of the first panel 610, wherein the first peripheral fringe 611 faces the first directing portion 7.

A structure of the second directing portion 8 is identical to that of the first directing portion 7, wherein the second directing portion 8 includes a second recess 81 defined on a second panel 620 of a case 62, and a second semicircular cover 82 integrally formed on the second recess 81, wherein the second semicircular cover 82 is arcuate, and multiple second elongated orifices 83 are separately formed on a side of a second peripheral fringe 621 of the second panel 620, wherein the second peripheral fringe 621 faces the second directing portion 8.

The first panel 610 of the cap 61 has a first arcuate sheet 63 extending from an inner wall thereof, and the second panel 620 of the case 62 has a second arcuate sheet 64 extending from an inner wall thereof and corresponding to the first arcuate sheet 63, wherein a third arcuate sheet of the case 62 is not shown.

Accordingly, the air inflator device of the present invention contains the accommodation box and the air compressor 9 received in the accommodation box, and the air guiding mechanism is also received in the accommodation box and is configured to frame the cooling fan 91 which is rotatably with the motor 92 of the air compressor 9. The air guiding mechanism is configured to collect and guide the airs so that the cooling fan 91 rotates to guide the airs to the air compressor 9, thus dissipating the heat and prolonging the service life of the air compressor 9.

While the preferred embodiments of the invention have been set forth for the purpose of disclosure, modifications of the disclosed embodiments of the invention and other embodiments thereof may occur to those skilled in the art. Accordingly, the appended claims are intended to cover all embodiments which do not depart from the spirit and scope of the invention.

What is claimed is:

1. An air inflator device comprising: an accommodation box and an air compressor, the accommodation box including a cap and a case, and the air compressor being received in the cap and the case, an air guiding mechanism being also received in the accommodation box and being configured to frame a cooling fan which is rotatably with a motor of the air compressor, characterized in that
a flowing orifice is defined by a first directing portion and a second directing portion, and a first semicircular cover and a second semicircular cover of the air guiding mechanism are configured to collect and guide airs so that the cooling fan rotates to guide the airs to the air compressor quickly, thus dissipating heat and prolonging a service life of the air compressor.

2. The air inflator device as claimed in claim 1, characterized in that the cap is formed in a rectangular frame shape and includes a first panel formed on a top of the cap, a button located beside the first panel and configured to turn on/off the air compressor, and a fluid guide structure which has a first directing portion.

3. The air inflator device as claimed in claim 2, characterized in that the first directing portion has a first recess defined on a side of a first peripheral fringe of the cap, and the first semicircular cover extending on the first recess, wherein the first semicircular cover has a first rib and a first arcuate fence, wherein the cap further includes multiple first elongated orifices separately formed on the first arcuate fence, and the first semicircular cover is integrally formed with the cap.

4. The air inflator device as claimed in claim 3, characterized in that the case is formed in a rectangular frame shape and includes a fluid guide structure has a second directing portion the same as the first directing portion, the second directing portion has a second recess defined on a side of a second peripheral fringe of the case below a second panel of a top of the case, and a second semicircular cover extending on the second recess, wherein the second semicircular cover has a second rib and a second arcuate fence; the cap further includes multiple first elongated orifices separately formed on the first arcuate fence, and the second semicircular cover is integrally formed with the case.

5. The air inflator device as claimed in claim 4, characterized in that after the air compressor is received in the cap and the case, the first directing portion of the cap and the second directing portion of the case frame the cooling fan, and the cooling fan is rotatably with the motor of the air compressor, thus avoiding a strike of the cooling fan; wherein a flowing orifice is defined by the first directing portion and the second directing portion.

6. The air inflator device as claimed in claim 5, characterized in that a first datum line is defined between the first peripheral fringe and the second peripheral fringe, a back line of the cooling fan located in an air flowing zone is defined as a second datum line; wherein the multiple first elongated orifices and the multiple second elongated orifices are located in an area between the first datum line and the second datum line; when the cooling fan rotates, the external airs are drawn into the accommodation box from the multiple first elongated orifices and the multiple second elongated orifices.

7. The air inflator device as claimed in claim 4, characterized in that the first panel of the cap has a first fixing extension extending on an inner wall thereof and configured to guide the airs and to fix the motor of the air compressor, and the second panel of the case has a second fixing extension extending on an inner wall thereof and configured to guide the airs and to fix the motor of the air compressor; the first fixing extension has a tilted face formed on a center thereof, a first tilted fence extending from a first end of the tilted face to the first peripheral fringe, a second tilted fence extending from a second end of the tilted face to the first peripheral fringe, wherein the tilted face, the first tilted fence, and the second tilted fence guide the airs forward smoothly, wherein a structure of the second fixing extension is identical to that of the first fixing extension.

8. The air inflator device as claimed in claim 7, characterized in that the first panel of the cap has a first arcuate sheet extending from an inner wall thereof, and the second panel of the case has a second arcuate sheet extending from an inner wall thereof and corresponding to the first arcuate sheet.

9. The air inflator device as claimed in claim 2, characterized in that wherein a first recess of a first directing portion is defined on a first panel of a cap, and a first semicircular cover is integrally formed on the first recess, wherein the first semicircular cover is arcuate, the cap further includes multiple first elongated orifices separately formed on a side of a first peripheral fringe of the first panel, and the first peripheral fringe faces the first directing portion.

10. The air inflator device as claimed in claim 9, characterized in that the case is formed in a rectangular frame shape and includes a fluid guide structure has the second directing portion the same as the first directing portion, wherein a structure of the second directing portion is identical to that of the first directing portion, wherein the second directing portion includes a second recess defined on a second panel of a case, and a second semicircular cover integrally formed on the second recess, wherein the second semicircular cover is arcuate, and multiple second elongated orifices are separately formed on a side of a second peripheral fringe of the second panel, wherein the second peripheral fringe faces the second directing portion.
